(19) United States
(12) Patent Application Publication
(10) Pub. No.: US 2009/0066611 A1
(43) Pub. Date: Mar. 12, 2009

(54) PLASMA DISPLAY APPARATUS AND METHOD OF DRIVING THE SAME

(76) Inventors: Kirack PARK, Gumi-city (KR); Jongwoon BAE, Gumi-city (KR); Seonghwan RYU, Gumi-city (KR)

Correspondence Address: KED & ASSOCIATES, LLP, P.O. Box 221200, Chantilly, VA, 20153-1200, US

(21) Appl. No.: 12/029,862

(22) Filed: Feb. 12, 2008

(30) Foreign Application Priority Data
Sep. 11, 2007 (KR) 10-2007-0092100

(51) Int. Cl. G09G 3/28

(52) U.S. Cl. 345/60

(57) ABSTRACT

A plasma display apparatus and a method of driving the same are disclosed. The plasma display apparatus includes a plasma display panel including scan electrodes and sustain electrodes, and a scan driver that supplies reset signals to the scan electrodes in reset periods of a plurality of subfields so that a period in which a lowest voltage of the reset signal is supplied varies with a reset period of at least one subfield.

This application claims the benefit of Korean Patent Application No. 10-2007-0092100 filed on Sep. 11, 2007, which is hereby incorporated by reference.

### BACKGROUND OF THE DISCLOSURE

1. Field of the Disclosure

This document relates to a plasma display apparatus and a method of driving the same.

2. Description of the Related Art

In general, in a plasma display panel (PDP), barrier ribs formed between a top surface panel and bottom surface panel form a unit discharge cell. Each discharge cell is filled with a main discharge gas such as neon (Ne), helium (He), or a gas mixture of Ne and He (Ne+He) and an inert gas comprising a small amount of xenon. A plurality of unit discharge cells forms one pixel. For example, red R cells, green (G) cells, and blue (B) cells are gathered to form one pixel. When a radiofrequency voltage is supplied to the unit discharge cells so that discharge is generated, the inert gas generates vacuum ultraviolet (UV) rays and emits light from phosphors formed between the barrier ribs so that an image is displayed. Since the PDP can be made thin and light, the PDP is spotlighted as a next generation display.

A plurality of electrodes, for example, scan electrodes Y, sustain electrodes Z, and address electrodes X and drivers for driving the electrodes are attached to the PDP to form a plasma display apparatus.

### SUMMARY OF THE DISCLOSURE

An aspect of this document is to provide a plasma display apparatus in which a period for which the lowest voltage of reset signals is supplied varies with each subfield so that it is possible to prevent erroneous discharge from being generated and to stably generate discharge and a method of driving the same.

In an aspect, there is provided a plasma display apparatus, comprising a plasma display panel (PDP) comprising scan electrodes and sustain electrodes and a scan driver that supplies reset signals to the scan electrodes in reset periods of a plurality of subfields so that a period in which a lowest voltage of the reset signal is supplied varies with a reset period of at least one subfield.

In another aspect, there is provided a method of driving a plasma display apparatus comprising scan electrodes and sustain electrodes, the method comprising supplying a lowest voltage of a first reset signal in a reset period of a first subfield of a plurality of subfields to the scan electrodes in a first sustain period, supplying a lowest voltage of the second reset signal in a reset period of a second subfield provided in a different way from the first subfield among the plurality of subfields to the scan electrodes in a second sustain period, supplying the second reset signal to the scan electrodes in a reset period of a third subfield provided in a different way from the first subfield and the second subfield among the plurality of subfields, and supplying erase signals to the scan electrodes in a sustain period after the reset period.

As described above, in the plasma display apparatus according to an embodiment of the present invention, a sustain period in which the lowest voltage of the reset signals is sustained varies with each subfield. Therefore, it is possible to prevent erroneous discharge from being generated and to prevent the image quality of an image from deteriorating.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates a plasma display apparatus according to an embodiment of the present invention;

FIG. 2 illustrates the structure of a plasma display panel (PDP) according to an embodiment of the present invention;

FIG. 3 illustrates a frame for displaying the gray levels of an image in a method of driving the plasma display apparatus according to an embodiment of the present invention;

FIG. 4 describes the operation of the method of driving the plasma display apparatus according to an embodiment of the present invention;

FIG. 5 describes a relationship between a first sustain bias voltage and a second sustain bias voltage according to an embodiment of the present invention;

FIG. 6 illustrates driving signals supplied to a plurality of subfields according to an embodiment of the present invention;

FIG. 7 illustrates a period in which the lowest voltage of reset signals supplied to scan electrodes according to an embodiment of the present invention; and

FIG. 8 describes that the intensity of discharge varies in accordance with a relationship between a first sustain period and a second sustain period according to an embodiment of the present invention.

### DETAILED DESCRIPTION OF EMBODIMENTS

Embodiments will be described in a more detailed manner with reference to the drawings.

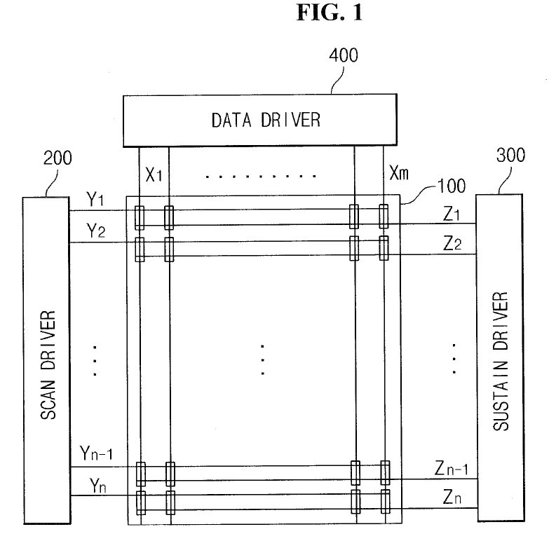

FIG. 1 illustrates a plasma display apparatus according to an embodiment of the present invention.

Referring to FIG. 1, the plasma display apparatus according to an embodiment of the present invention comprises a plasma display panel (PDP) 100, a scan driver 200, a sustain driver 300, and a data driver 400.

In the PDP 100, a top surface panel (not shown) and a bottom surface panel (not shown) are attached to each other by a predetermined distance. The PDP 100 comprises scan electrodes Y1 to Yn, sustain electrodes Z1 to Zn, and address electrodes X1 to Xm.

The scan driver 200 supplies reset signals to the scan electrodes Y1 to Yn so that wall charges are uniformly formed in discharge cells in a reset period.

At this time, the scan driver 200 supplies the reset signals to the scan electrodes in the reset periods of a plurality of subfields so that a period in which the lowest voltage of the reset signals is supplied varies in the reset period of at least one subfield.

Then, the scan driver 200 supplies scan signals for selecting discharge cells in which discharge is to be generated to the scan electrodes Y1 to Yn in an address period and supplies sustain signals to generate sustain discharge in the selected discharge cells to the scan electrodes Y1 to Yn in a sustain period.

The sustain driver 300 supplies sustain bias signals to the sustain electrodes Z1 to Zn in a set down period and in the address period. At this time, the sustain bias signals comprise a first sustain bias voltage and a second sustain bias voltage having a different voltage from the first sustain bias voltage.

In addition, the sustain driver 300 supplies sustain signals to the sustain electrodes Z1 to Zn in a sustain period.

In addition, the sustain driver 300 supplies a positive polar voltage lower than the highest voltage of the sustain signals to the sustain electrodes after the sustain period of a third subfield provided latest in a first frame consisting of a plurality of subfields before the reset period of a first subfield provided earliest in a second from consisting of a plurality of subfields.

The data driver 400 supplies data mapped to the subfields, respectively, by a subfield mapping circuit after being reverse gamma corrected and error diffused by a reverse gamma correcting circuit and an error diffusing circuit (not shown).

In addition, the data driver 400 supplies data signals to the address electrodes X1 to Xm in the address period in response to data timing control signals supplied from a timing controller (not shown) to correspond to the scan electrodes Y1 to Yn.

The structure of the PDP comprised in the plasma display apparatus will be described as follows.

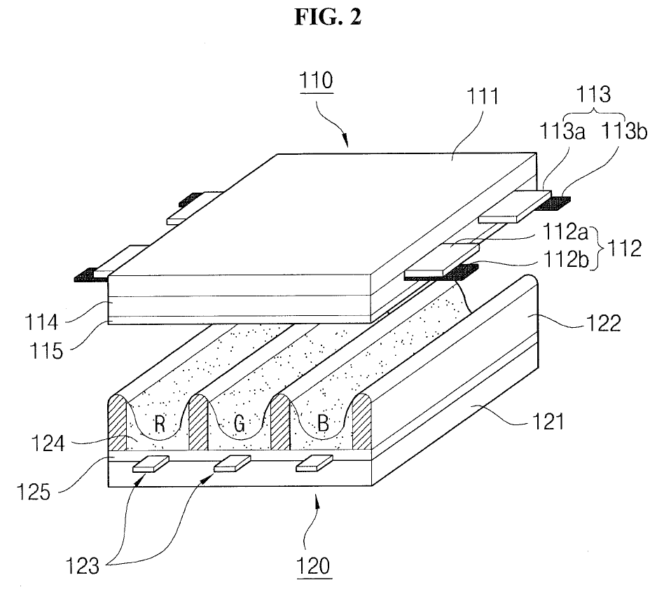

FIG. 2 illustrates the structure of a plasma display panel (PDP) according to an embodiment of the present invention.

Referring to FIG. 2, the PDP according to an embodiment of the present invention is formed by attaching a top surface panel 110 comprising a top surface substrate 111 on which a scan electrode 112 and a sustain electrode 113 are formed and a bottom surface panel 120 comprising a bottom surface substrate 121 on which address electrodes 123 that intersect the scan electrodes 112 and the sustain electrodes 113 are formed to each other by a predetermined distance.

Here, the scan electrode 112 and the sustain electrode 113 run parallel with each other on the top surface substrate 111 to generate discharge in discharge cells Cell and to sustain the discharge of the discharge cells.

The scan electrode 112 and the sustain electrode 113 formed on the top surface substrate 111 emit light generated by the discharge cells to the outside in consideration of transmittance and conductivity in order to secure driving efficiency. Therefore, the scan electrode 112 and the sustain electrode 113 comprise bus electrodes 112b and 113b made of a metal such as Ag and transparent electrodes 112a and 113a made of transparent indium tin oxide (ITO).

An upper dielectric layer 114 can be formed on the top surface substrate 111 where the scan electrode 112 and the sustain electrode 113 are formed to cover the scan electrode 112 and the sustain electrode 113.

The upper dielectric layer 114 limits the discharge current of the scan electrode 112 and the sustain electrode 113 to insulate the scan electrode 112 from the sustain electrode 113.

A protective layer 115 for facilitating discharge can be formed on the upper dielectric layer 114. The protective layer 115 can be made of a material having a high secondary electron emission coefficient such as magnesium oxide (MgO).

On the other hand, the address electrodes 123 formed on the bottom surface substrate 121 supply the data signals Data to the discharge cells.

A lower dielectric layer 125 can be formed on the bottom surface substrate 121 where the address electrodes 123 are formed to cover the address electrodes 123.

Barrier ribs 122 for partitioning off discharge spaces, that is, the discharge cells are formed on the lower dielectric layer 125. Phosphor layers 124 for emitting visible rays for displaying an image during address discharge are formed in the discharge cells partitioned off by the barrier ribs 122. For example, red (R), green (G), and blue (B) phosphor layers can be formed.

In the PDP according to an embodiment of the present invention as described above, when driving signals are supplied to the scan electrode 112, the sustain electrode 113, and the address electrodes 123, discharge is generated by the discharge cells partitioned off by the barrier ribs to display an image.

In FIG. 2, the PDP according to an embodiment of the present invention is illustrated and described. However, the present invention is not limited to the above.

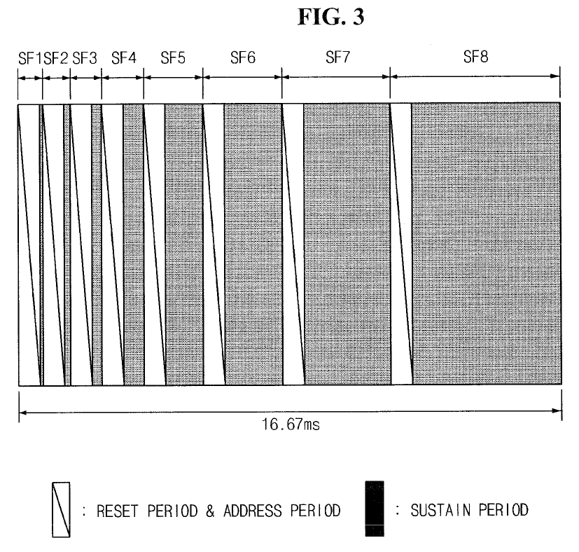

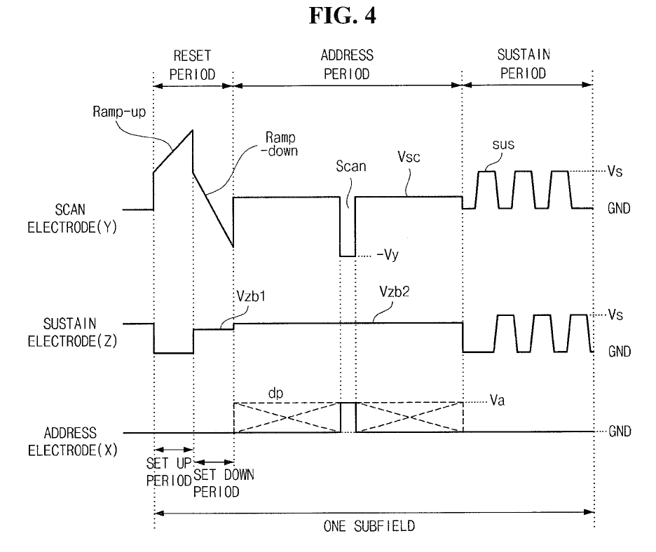

The operation of the plasma display apparatus according to an embodiment of the present invention comprising the PDP will be described with reference to FIGS. 3 and 4.

FIG. 3 illustrates a frame for displaying the gray levels of an image in a method of driving the plasma display apparatus according to an embodiment of the present invention. FIG. 4 describes the operation of the method of driving the plasma display apparatus according to an embodiment of the present invention.

First, referring to FIG. 3, in the plasma display apparatus according to an embodiment of the present invention, a frame for realizing the gray levels of an image is divided into various subfields having different number of times of emission.

In addition, although not shown, each of the subfields can be divided into a reset period for initializing all of the discharge cells, an address period for selecting discharge cells to be discharged, and a sustain period for realizing gray levels in accordance with the number of times of discharge.

For example, when an image is to be displayed by 256 gray levels, a frame period (16.67 ms) corresponding to 1/60 second is divided into, for example, eight subfields SF1 to SF8 as illustrated in FIG. 3 and each of the eight subfields SF1 to SF8 is divided into a reset period, an address period, and a sustain period. At least one of the reset period and the sustain period can be omitted from at least one subfield in consideration of a driving margin and gray level display.

On the other hand, the number of sustain signals supplied in the sustain period can be controlled to set the gray level weight value of a corresponding subfield. That is, a predetermined gray level weight value can be provided to each of the subfields using the sustain period. For example, the gray level weight value of each of the subfields can be determined so that the gray level weight value of each of the subfields increases in the ratio of 2ⁿ (n=0, 1, 2, 3, 4, 5, 6, and 7) by setting the gray level weight value of the first subfield as 2⁰ and by setting the gray level weight value of the second subfield as 2¹. As described above, the number of sustain signals supplied in the sustain period of each of the subfields is controlled in accordance with the gray level weight value of each of the subfields to realize the gray levels of various images.

FIG. 4 illustrates driving shapes that can be applied to one of the plurality of subfields comprised in the frame of FIG. 3.

The scan driver 200, the sustain driver 300, and the data driver 400 described in FIG. 1 supply the driving signals to the scan electrodes Y, the sustain electrodes Z, and the address electrodes X in at least one period of the reset period, the address period, and the sustain period.

The scan driver 200 supplies the reset signals to the scan electrodes Y in the reset period. The reset signals comprise rising reset signals Ramp-up that rise to the highest voltage of the reset signals and falling reset signals Ramp-down that fall to the lowest voltage of the reset signals.

In addition, although not shown in FIG. 4, the reset signals can comprise a first reset signal and a second reset signal. The first reset signal can comprise the rising reset signals Ramp-up and the falling reset signals Ramp-down and the second reset signal can comprise the falling reset signals Ramp-down.

The scan driver can supply the rising reset signals Ramp-up to the scan electrodes Y in the set up period of the reset period. Due to the rising reset signals, weak dark discharge is generated in the discharge cells of an entire screen. Positive polar wall charges are accumulated on the address electrodes X and the sustain electrodes Z and negative polar wall charges are accumulated on the scan electrodes Y due to the set up discharge. The discharge caused by the rising reset signals reduces discharge delay time in the address period and generates priming particles for smoothly generating the address discharge, that is, exciting particles for the address discharge. The voltage of the rising reset signals gradually increases from a voltage no more than a discharge start voltage to a voltage larger than the discharge start voltage.

In addition, the scan driver 200 can supply the rising reset signals to the scan electrodes Y in the set down period and then, can supply the falling reset signals Ramp-down that start to fall from a positive polar voltage lower than the highest voltage of the rising reset signals and that fall to a specific voltage level no more than a ground voltage level GND.

Therefore, weak erase discharge is generated in the discharge cells so that wall charges excessively formed in the discharge cell can be sufficiently erased. Wall charges that can stably generate the address discharge uniformly reside in the discharge cells due to the set down discharge.

The sustain driver 300 supplies a sustain bias voltage Vzb to the sustain electrodes Z in the set down period and the address period. The sustain bias voltage Vzb comprises a first sustain bias voltage Vab1 and a second sustain bias voltage Vzb2. The sustain driver 300 supplies the first sustain bias voltage Vzb1 to the sustain electrodes Z in the set down period and supplies the second sustain bias voltage Vzb2 to the sustain electrodes Z in the address period to prevent discharge from being generated between the sustain electrodes Z and the address electrodes X and to prevent erroneous discharge from being generated.

That is, the second sustain bias voltage Vzb2 higher than the first sustain bias voltage Vzb1 supplied in the set down period is supplied in the address period to supply a higher voltage to the sustain electrodes Z in the address period, to prevent discharge between the sustain electrodes Z and the address electrodes X, and to effectively generate opposed discharge between the scan electrodes Y and the address electrodes X.

At this time, a difference between the first sustain bias voltage and the second sustain bias voltage comprised in the sustain bias signal Vzb can be no less than 2V and no more than 10V. A voltage difference between the first sustain bias voltage and the second sustain bias voltage may be no less than 3V and no more than 5V.

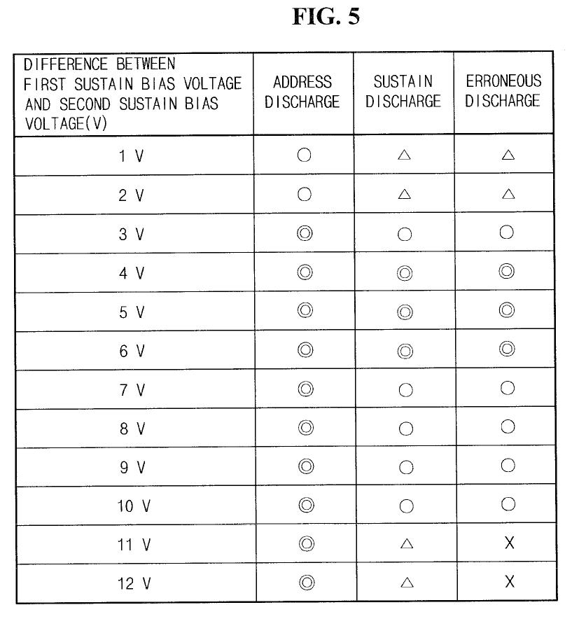

When such a voltage difference is provided, the opposed discharge between the sustain electrodes Z and the address electrodes X can be prevented and the address discharge between the scan electrodes Y and the address electrodes X can be activated. Detailed description thereof will be performed in FIG. 5.

In addition, the scan driver 200 can supply negative polar scan signals that fall from a scan bias voltage Vsc to the scan electrodes Y in the address period. Here, the scan bias voltage Vsc can be larger than the ground voltage level GND. Furthermore, the scan bias voltage Vsc can be lower than t he highest voltage of the sustain signals supplied to the scan electrodes Y in the sustain period and higher than the lowest voltage of the reset signals.

The scan bias voltage Vsc is made larger than the ground voltage level GND so that the negative polar wall charges formed on the scan electrodes Y in the reset period can be firmly accumulated. In addition, when the scan bias voltage Vsc is supplied in the address period, a voltage difference between the scan electrodes Y and the sustain electrodes Z is increased so that the address discharge can be stably generated.

Furthermore, the data driver 400 supplies positive polar data signals to the address electrodes X to correspond to a negative polar scan signal Scan.

A voltage difference between the scan signal Scan and the data signals DP and a wall voltage generated in the reset period are added so that the address discharge is generated in the discharge cells to which the data signals dp are supped. Wall charges that can generate discharge when the sustain voltage Vs is supplied are formed in the discharge cells selected by the address discharge.

At this time, the lowest voltage of the reset signal Scan is lower than the lowest voltage of the sustain signals SUS supplied to the scan electrodes Y in the sustain period and can be higher than the lowest voltage of the scan signal Scan. Therefore, the lowest voltage of the scan signal Scan can be a negative polar voltage lower than the lowest voltage of the reset signals. Here, the reset signals comprise the first reset signal and the second reset signal.

A negative polar voltage in which the lowest voltage of the scan signal Scan is lower than the lowest voltage of the reset signals is supplied to the scan electrodes Y so that the highest voltage of the data signals dp can be reduced and that the address discharge can be effectively generated.

In the sustain period after the address period, the scan driver 200 and the sustain driver 300 supply the sustain signals SUS to the scan electrodes Y and the sustain electrodes Z. Therefore, in the discharge cells selected by the address discharge, the wall voltage in the discharge cells and the sustain signals SUS are added to each other so that sustain discharge is generated between the scan electrodes Y and the sustain electrodes Z whenever the sustain signals SUS are supplied.

The driving method was described according to an embodiment of the present invention. The scan driver 200 can supply erases signals that erase wall charges left after the sustain discharge after the last sustain signal SUS is supplied in the sustain period to the scan electrodes Y or the sustain electrodes Z.

FIG. 5 describes a relationship between a first sustain bias voltage and a second sustain bias voltage according to an embodiment of the present invention.

In FIG. 5, address discharge, sustain discharge, and erroneous discharge realized while changing a difference between the first sustain bias voltage and the second sustain bias voltage from 1V to 12V are measured.

⊚ represents that wall charges are very smoothly formed in the discharge cells to stably generate the address discharge and to easily generate the sustain discharge and that erroneous discharge is not generated. ◯ represents that the sustain discharge is relatively smoothly generated. Δ 20 represents that the sustain discharge is not smoothly generated. X represents that the address discharge is unstably generated and the sustain discharge can be unstably generated so that wall charges are excessively or insufficiently formed in the discharge cells and that erroneous discharge is generated.

First, when a difference between the first sustain bias voltage Vzb1 and the second sustain bias voltage Vzb2 is within 2V, the address discharge is smoothly generated, however, wall charges can be excessively formed in the discharge cells after the address discharge so that the sustain discharge is not smoothly generated and that erroneous discharge can be generated. That is, the sustain discharge is not smoothly generated.

In addition, when a difference between the first sustain bias voltage Vzb1 and the second sustain bias voltage Vzb2 is no less than 10V, the address discharge is very smoothly generated, however, wall charges can be insufficiently formed in the discharge cells after the address discharge so that the sustain discharge is not smoothly generated and that erroneous discharge can be generated. That is, the sustain discharge is not smoothly generated so that erroneous discharge is often generated.

In addition, when a difference between the first sustain bias voltage Vzb1 and the second sustain bias voltage Vzb2 is no less than 3V and no more than 10V, the address discharge is very smoothly generated and wall charges are smoothly formed in the discharge cells after the address discharge so that the sustain discharge is easily generated. Therefore, probability of generating erroneous discharge is reduced. That is, the sustain discharge as well as the address discharge is smoothly generated so that erroneous discharge is rarely generated. A difference between the first sustain bias voltage Vzb1 and the second sustain bias voltage Vzb2 may be no less than 4V and no more than 6V so that the address discharge and the sustain discharge are stably generated so that erroneous discharge is not generated.

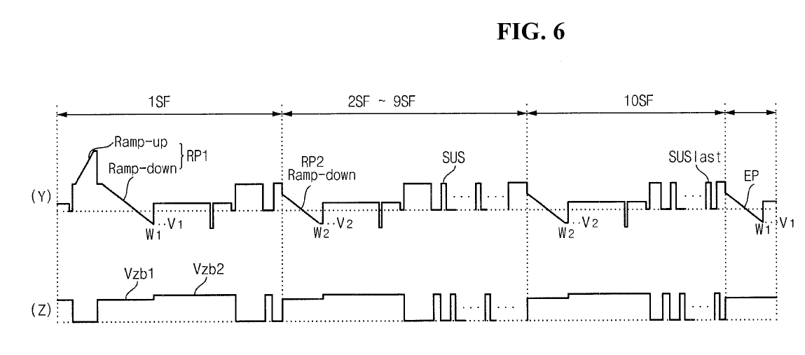

FIG. 6 illustrates driving signals supplied to a plurality of subfields according to an embodiment of the present invention.

Referring to FIG. 6, the scan driver 200 according to an embodiment of the present invention varies a period in which the lowest voltage of the reset signals supplied to the scan electrodes Y in the reset period with each of the plurality of subfields.

At this time, the period in which the lowest voltage of the reset signals is supplied comprises a first sustain period W1 and a second sustain period W2 different from the first sustain period W1. That is, the first sustain period W1 in which the lowest voltage of the reset signals is sustained is different from the second sustain period W2 in which the lowest voltage of the reset signals is sustained.

Since the frame consisting of the plurality of subfields was fully described in FIG. 3, detailed description thereof will be omitted in FIG. 6.

In the reset period of the first subfield 1SF provided earliest in the plurality of subfields, a first reset signal RP1 comprising the first sustain period W1 can be supplied. In the reset period of the second subfield 2SF, a second reset signal RP2 comprising the second sustain period W2 can be supplied.

The voltage swing width of the first reset signal RP1 supplied to the scan electrodes Y in the reset period of the first subfield 1SF is larger than the voltage swing width of the second reset signal RP2 supplied to the scan electrodes Y in the reset period of the second subfield 2SF. That is, a voltage range that can change from the highest voltage of the first reset signal RP1 to the lowest voltage V1 of the first reset signal RP1 is larger than a voltage range that can change from the highest voltage of the second reset signal RP2 to the lowest voltage V2 of the second reset signal RP2.

Therefore, the first reset signal RP1 whose voltage swing width is larger than the voltage swing width of the second reset signal RP2 is supplied to the scan electrodes Y in the reset period of the first subfield 1SF among the plurality of subfields so that wall charges can be sufficiently accumulated in the discharge cells of an entire screen, that wall charges formed in the discharge cells can be sufficiently erased, and that wall charges can uniformly reside in the discharge cells.

Therefore, wall charges that can stably generate the address discharge although the second reset signal RP2 whose voltage swing width is smaller than the voltage swing width of the first reset signal RP1 is supplied to the scan electrodes Y in the reset period of the second subfield 2SF provided after the first subfield 1SF can be continuously sustained in the discharge cells.

Here, in the reset periods of the remaining subfields provided after the second subfield 2SF, the second reset signal RP2 can be supplied to the scan electrodes Y. The reason why the second reset signal RP2 is supplied to the scan electrodes Y in the reset periods of the remaining subfields provided after the second subfield 2SF is actually the same as the reason why the second reset signal RP2 is supplied to the scan electrodes Y in the reset period of the second subfield 2SF.

In addition, the first reset signal applied to the first subfield 1SF comprises the rising reset signals Ramp-up whose voltage gradually increases with the lapse of time and the falling reset signals Ramp-down whose voltage is gradually reduced with the lapse of time. On the other hand, in the remaining subfields (2SF to 10SF), THE RISING RESET SIGNALS Ramp-up are not comprises and the falling reset signals Ramp-down whose voltage is gradually reduced with the lapse of time can be supplied to the scan electrodes Y.

Therefore, a voltage range in which the first reset signal RP1 can change can be no less than 100V and no more than 240V and a voltage range in which the second reset signal RP2 can change can be no less than −90V and no more than 200V.

Therefore, the absolute value of the lowest voltage of the first reset signal RP1 can be different from the absolute value of the lowest voltage of the second reset signal RP2. The lowest voltage V1 of the first reset signal RP1 can be no less than −100V and no more than −95V and the lowest voltage V2 of the second reset signal RP2 can be no less than −90V and no more than −80V.

On the other hand, according to an embodiment of the present invention, a period in which the sustain voltage that is the highest voltage of the sustain signal last supplied to the scan electrodes Y is supplied can vary with at least one subfield. This is because the last sustain discharge generated by the last sustain signal is used for initializing the discharge cell in the reset period of the next subfield. That is, since the state of the wall charges of the reset periods of the plurality of subfields can vary, the width of the last sustain signal can be controlled to be used for optimizing the state of the wall charges in the next reset period.

In addition, in the sustain period of the third subfield provided latest in the first frame consisting of the plurality of subfields and in the reset period of the first subfield 1SF provided earliest in the second frame provided after the last sustain signal SUS last and the first frame, erase signals EP can be supplied to the scan electrodes Y before the first reset signal RP1 is supplied to the scan electrodes Y. As described above, the erase signals EP are supplied so that wall charges can uniformly reside in the discharge cells. This is because most wall charges non-uniformly formed by the erase discharge caused by the erase signals EP are erased.

The voltage of the erase signals EP is gradually reduced with the lapse of time. At least one of the highest voltage of the erase signals EP, the lowest voltage V1 of the erase signals EP, and the falling slope of the erase signals EP can be actually the same as the highest voltage of the second reset signal RP2, the lowest voltage V1 of the first reset signal RP1, and the falling slopes of the first and second reset signals RP1 and RP2.

In addition, the erase signals EP can be supplied to the scan electrodes Y in the erase period after the sustain period and can be supplied to the scan electrodes Y in a pre-reset period before the reset period.

The erase signals EP are supplied to the scan electrodes Y so that wall charges can be uniformly formed in the discharge cell. Therefore, the erase signals EP only have to be comprised in at least one of the reset period, the sustain period, the erase period, and the pre-reset period to effectively uniformize wall charges in the discharge cells and is not limited to the above.

On the other hand, the second sustain bias voltage Vzb2 in the first subfield can be different from the second sustain bias voltage Vzb2 in the remaining subfields. That is, the second sustain bias voltage Vzb2 in the first subfield 1SF can be larger than the second sustain bias voltage Vzb2 in the remaining subfields.

Since the first subfield 1SF commonly displays lower gray levels than the remaining subfields 2SF to 10SF, the number of turned on discharge cells is small. Therefore, the turned on discharge cells cannot expect priming effect from peripheral discharge cells since little discharge cells are turned on in the vicinity. Therefore, the amount of wall charges accumulated by the address discharge in the address period can be insufficient. In this case, although the sustain signals are supplied in the sustain period, the sustain discharge may not be generated due to insufficient wall charges. Therefore, in order to form sufficient wall charges in the address period of the first subfield 1SF, the second sustain bias voltage Vzb2 can be made larger than the second sustain bias voltage Vzb2 in the remaining subfields 2SF to 10SF.

On the other hand, in the remaining subfields 2SF to 10SF excluding the first subfield 1SF, since relatively high gray levels are displayed, the second sustain bias voltage Vzb2 needs not be high. For example, when the second sustain bias voltage Vzb2 equal to the second sustain bias voltage Vzb2 supplied in the first subfield 1SF is supplied in the remaining subfields, wall charges are excessively formed in the address period so that undesired discharge can be generated in non-discharge cells in the sustain period.

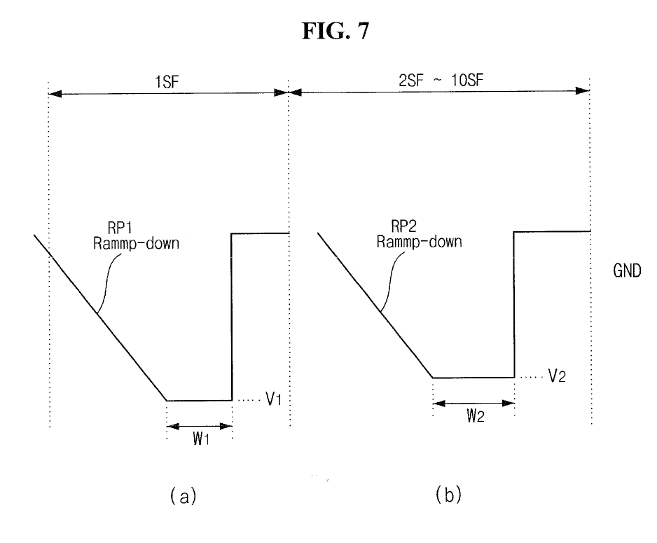

FIG. 7 illustrates a period in which the lowest voltage of reset signals supplied to scan electrodes according to an embodiment of the present invention.

Referring to FIG. 7, the first sustain period W1 in which the lowest voltage of the first reset signal supplied to the scan electrodes is sustained according to an embodiment of the present invention is compared with the second sustain period W2 in which the lowest voltage of the second reset signal is sustained.

The first reset signal RP1 supplied to the scan electrodes Y in the reset period of the first subfield 1SF among the plurality of subfields comprises the first sustain period W1. The second reset signal RP2 supplied to the scan electrodes Y in the reset periods of the remaining subfields 2SF to 10SF excluding the first subfield 1SF comprises the second sustain period W2.

At this time, the first sustain period W1 in which the lowest voltage V1 of the first reset signal RP1 is sustained can be shorter than the second sustain period W2 in which the lowest voltage V2 of the second reset signal RP2 is sustained. As the sustain period in which the lowest voltage of the reset signals is sustained increases, a period in which wall charges formed in the discharge cells are erased increases so that wall charges can be uniformly formed in the discharge cells.

That is, in the first subfield 1SF, the amount of wall charges generated by the discharge cells by the rising reset signals whose voltage is gradually increased in the scan electrodes can be smaller than the amount of wall charges formed in the discharge cells by the last sustain signal that helps the reset period of the next subfield in the remaining subfields.

This is because most wall charges in the discharge cells are erased by the erase signals EP supplied to the scan electrodes in the last subfield of a previous frame so that the amount of priming particles is small and that the amount of wall charges formed by the rising signals supplied to the scan electrodes in the first subfield can be smaller than when the erase signals EP are not supplied.

Therefore, in the first subfield, the first sustain period W1 of the first reset signal RP1 is made shorter than the second sustain period W2 of the second reset signal RP2 so that the amount of erased wall charges is smaller than the amount of wall charges erased in the reset periods of the remaining subfields 2SF to 10SF.

In addition, the sustain period W1 of the lowest voltage of the erase signals EP supplied to the third subfield provided latest among the plurality of subfield is made actually the same as the first sustain period W1 of the first subfield so that the priming particles are not excessively erased.

On the other hand, according to an embodiment of the present invention, the lowest voltage value V1 in the reset period of the first subfield may be smaller than the lowest voltage value V2 in the reset periods of the remaining subfields. For example, when the voltage value of V1 is −90V, the voltage value of V2 may be −85V so that a difference between two voltage values may be 5V to 10V. Therefore, the entire time of the reset periods is reduced to secure the driving margin.

In addition, the second sustain bias voltage supplied to the sustain electrodes Z of FIG. 4 may be supplied to correspond to the point of time at which the first sustain period W1 or the second sustain period W2 is terminated.

This is because, when the second sustain bias voltage is rapidly supplied to the first or second sustain period W1 or W2, noise is generated while the first or second sustain period W1 or W2 is supplied to the scan electrodes Y to deteriorate driving reliability.

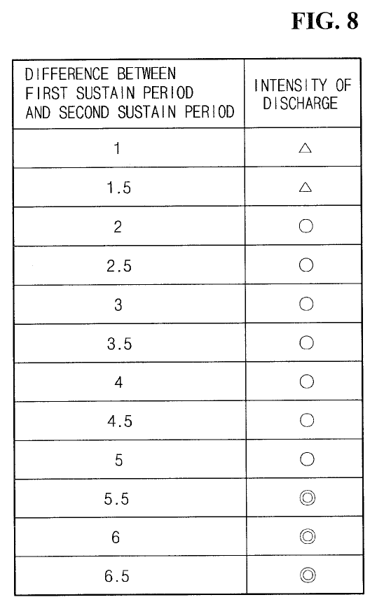

FIG. 8 describes that the intensity of discharge varies in accordance with a relationship between a first sustain period and a second sustain period according to an embodiment of the present invention.

In FIG. 8, the multiple number of the first sustain period is changed from one time to 6.5 times based on the second sustain period to measure the intensities of discharge generated in the discharge cells.

⊚ represents that the intensity of discharge generated by the discharge cells is too excessive. ◯ represents that the intensity of discharge generated by the discharge cells is high. Δ represents that the intensity of discharge generated by the discharge cells is insufficient.

First, the second sustain period W2 is sustained by no more than two times the first sustain period W1 so that reset discharge is generated, wall charges in the discharge cells may not be sufficiently erased to deteriorate the reliability of the address discharge. This is because the intensity of discharge generated by the discharge cells is insufficient.

On the other hand, when the second sustain period W2 is sustained by no less than five times the first sustain period W1 so that the reset discharge is generated, wall charges in the discharge cells are excessively erased to deteriorate the reliability of the address discharge or the driving margin. This is because the intensity of discharge generated by the discharge cells is too excessive.

Therefore, a relationship between the first sustain period W1 and the second sustain period W2 may be 2W1<W2<5W1. When the reset discharge is generated in the discharge cells in such a range, wall charges in the discharge cells are properly erased so that the address discharge is stably generated.

In addition, according to an embodiment of the present invention, the first sustain period W1 is commonly and previously set as a specific value and the second sustain period W2 can be set in consideration of the set first sustain period W1. For example, the first sustain period W1 can be set as about 5 us to 15 us so that the second sustain period W2 can be set as about 10 us to 40 us. Therefore, the reliability of the address discharge and the driving margin are improved.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
a plasma display panel comprising scan electrodes and sustain electrodes; and
a scan driver that supplies reset signals to the scan electrodes in reset periods of a plurality of subfields so that a period in which a lowest voltage of the reset signal is supplied varies with a reset period of at least one subfield.

2. The plasma display apparatus of claim 1, wherein the plurality of subfields comprises a first subfield and a second subfield provided in a different way from the first subfield,
wherein the first reset signal is supplied in a reset period of the first subfield, and
wherein the second reset signal is supplied in a reset period of the second subfield.

3. The plasma display apparatus of claim 2, wherein the first subfield is provided earlier than the second subfield in one frame consisting of the plurality of subfields, and
wherein a first sustain period in which a lowest voltage of the first reset signal is supplied is shorter than a second sustain period in which a lowest voltage of the second reset signal is supplied.

4. The plasma display apparatus of claim 2, wherein the first reset signal comprises rising signals whose voltage gradually increases with a lapse of time and falling signals whose voltage is gradually reduced with a lapse of time, and wherein the second reset signal does not comprise the rising signals whose voltage gradually increases with the lapse of time.

5. The plasma display apparatus of claim 2, wherein an absolute value of a lowest voltage of the first reset signal is different from an absolute value of a lowest voltage of the second reset signal.

6. The plasma display apparatus of claim 3, wherein the second sustain period is no less than two times and no more than five times the first sustain period.

7. The plasma display apparatus of claim 2, further comprising a sustain driver that supplies sustain bias signals that rise from a first sustain bias voltage to a second sustain bias voltage to the sustain electrodes to correspond to a point of time at which the lowest voltage of the first reset signal or the second reset signal is terminated.

8. The plasma display apparatus of claim 7, wherein a difference between the first sustain bias voltage and the second sustain bias voltage is no less than 3 v and no more than 10V.

9. The plasma display apparatus of claim 8, wherein a difference between the first sustain bias voltage and the second sustain bias voltage is no less than 4V and no more than 6V.

10. A method of driving a plasma display apparatus comprising scan electrodes and sustain electrodes, the method comprising:
supplying a lowest voltage of a first reset signal in a reset period of a first subfield of a plurality of subfields to the scan electrodes in a first sustain period;
supplying a lowest voltage of the second reset signal in a reset period of a second subfield provided in a different way from the first subfield among the plurality of subfields to the scan electrodes in a second sustain period;
supplying the second reset signal to the scan electrodes in a reset period of a third subfield provided in a different way from the first subfield and the second subfield among the plurality of subfields; and
supplying erase signals to the scan electrodes in a sustain period after the reset period.

11. The method of claim 10, wherein scan signals are supplied to the scan electrodes in an address period after the reset period, and
wherein a lowest voltage of the scan signals is a negative voltage lower than a lowest voltage of the first reset signal or the second reset signal.

12. The method of claim 11, wherein the lowest voltage of the first reset signal or the second reset signal is lower than a lowest voltage of sustain signals supplied to the scan electrodes in the sustain period and is higher than a lowest voltage of the scan signals.

13. The method of claim 12, wherein the scan bias voltage is lower than the lowest voltage of the sustain signals supplied to the scan electrodes in the sustain period and higher than the lowest voltage of the first reset signal or the second reset signal.

14. The method of claim 10, wherein the first subfield is provided earlier than the second subfield in one frame consisting of the plurality of subfields, and
wherein a first sustain period in which the lowest voltage of the first reset signal is supplied is shorter than a second sustain period in which the lowest voltage of the second reset signal is supplied.

15. The method of claim 10, wherein the first reset signal comprises rising signals whose voltage gradually increases with a lapse of time and falling signals whose voltage is gradually reduced with a lapse of time, and
wherein the second reset signal does not comprise the rising signals whose voltage gradually increases with the lapse of time.

16. The method of claim 10, wherein an absolute value of a lowest voltage of the first reset signal is larger than an absolute value of a lowest voltage of the second reset signal.

17. The method of claim 10, further comprising supplying sustain bias signals that rise from a first sustain bias voltage to a second sustain bias voltage to the sustain electrodes to correspond to a point of time at which the lowest voltage of the first reset signal or the second reset signal is terminated.

18. The method of claim 10, further comprising supplying a positive polar voltage lower than a highest voltage of sustain signals to the sustain electrodes while the erase signals are supplied to the scan electrodes,
wherein the third subfield is provided latest in one frame consisting of the plurality of subfields.

19. The method of claim 18, wherein the erase signals comprise signals whose voltage is gradually reduced.

20. The method of claim 19, wherein a period in which a lowest voltage of the erase signals is supplied is actually the same as a period in which the lowest voltage of the first reset signal is supplied and is shorter than a period in which the lowest voltage of the second reset signal is supplied.
